(19) United States
(12) Patent Application Publication
(10) Pub. No.: US 2005/0263998 A1
(43) Pub. Date: Dec. 1, 2005

(54) Combination indoor and outdoor slide usable on both hard surfaces and carpeted surfaces

(76) Inventor: Donald V. Edwards, Harrison City, PA (US)

Correspondence Address: JAMES RAY & ASSOCIATES, 2640 PITCAIRN ROAD, MONROEVILLE, PA, 15146, US

(21) Appl. No.: 11/141,852

(22) Filed: Jun. 1, 2005

Related U.S. Application Data
(60) Provisional application No. 60/576,253, filed on Jun. 1, 2004.

(51) Int. Cl. A62B 9/04

(52) U.S. Cl. 280/845

(57) ABSTRACT

An indoor or outdoor slide apparatus usable on each of a hard surface and a carpeted surface includes a flexible member having each of a predetermined thickness and coefficient of friction sufficiently low to permit movement of the apparatus over a surface carrying up to 300 pounds is thereon, an upper surface and a bottom surface engageable with one of a hard surface and a carpeted surface. The flexible member formed into a shape which is devoid of any sharp edges which could be caught in and on such carpeted surface and which would have an adverse impact on movement of the apparatus over such carpeted surface. A moving and positioning mechanism is engageable with a portion of the flexible member for enabling moving and positioning the apparatus as required. A portion of such moving and positioning mechanism is attached to a predetermined portion of the flexible member.

### CROSS REFERENCE TO RELATED APPLICATIONS

This application is closely related to and claims benefit from U.S. Provisional Application Ser. No. 60/576,253 filed Jun. 01, 2004.

### FIELD OF THE INVENTION

The present invention relates, in general, to various types of apparatus used to move preselected objects from one place to another and, more particularly, this invention relates to a slide type apparatus which can be used inside on carpeted surfaces for sliding items into and out from under a bed for storage, or outside under a porch for example, and, still more specifically, the present invention relates to a slide type apparatus which can be used outdoors on grass as a sled or wheel barrel type apparatus during summer, or on other hard surfaces, such as concrete and/or gravel, as a creeper to slide under an automobile or truck if desired.

### BACKGROUND OF THE INVENTION

Prior to the conception and development of the present invention, slides for moving furniture and appliances in homes and offices, for example, have been known and are generally in widespread use. These known prior art type slides, in some cases, may be left under the item of furniture, or appliance, to be moved and in other cases these slides will be removed after they have been moved to their final place in the room. As a general rule the relatively small slides are normally left under the item and the larger slides will usually be removed from beneath such item.

In some cases, however, depending on the particular design of the slide, these relatively small slides might even be semi-permanently attached to the bottom of the furniture by one of a screw, nail, and/or a double sided adhesive.

Generally speaking these particular slides, including the larger slides, are still relatively small and would not be suitable for moving a relatively large item to be positioned under a bed for storage. One such item might be, for example, a suitcase, particularly, a suitcase having a soft outer surface.

Another area where these prior art type slides cannot be effectively used is, by way of example only, to move groceries from an entry way to an area where they will be stored and/or used. Nor can they be used as a wheel barrel to move items, such as grass clippings or tools, fertilizer, water or plants, etc., utilized in gardening, over the ground outside.

Additionally, it is well known in the prior art to use creepers to lie on while working underneath a car, or truck, for example. These prior art type creepers are used to slide under and out from under the vehicle and are therefore mounted on wheels which roll relatively easy over a hard and relatively smooth concrete surface. They are normally made out of wood, or other relatively hard materials, in order to provide the strength necessary to support the creeper on such wheels or casters. Consequently, these prior art type creepers are relatively expensive to both purchase and maintain. Even though these prior art creepers may work on bare ground, or grass, they are not capable of being slid over gravel and/or stone driveways. Furthermore, they generally require the surface to be relatively level in order to prevent undesirable movement during use.

Still it is equally well known in the prior art to use sleds for sliding over snow covered terrain during the winter months for entertainment. However, these prior art type sleds are used only in winter months and then only on snow covered ground.

### SUMMARY OF THE INVENTION

The present invention, according to a first aspect, provides a slide type apparatus which can be used indoors on carpeted surfaces or equally as well outdoors on a number of hard surfaces. The apparatus includes a flexible member having each of a first predetermined thickness, a first predetermined coefficient of friction which is at least sufficiently low to permit movement of the apparatus over a predetermined surface when a load of up to about 300 pounds is disposed thereon, an upper surface and a radially opposed bottom surface engageable with one of a hard surface and a carpeted surface. The flexible member being formed into a predetermined shape. Such predetermined shape will at least be devoid of any sharp edges which could be caught at least one of in and on such carpeted surface and which would have an adverse impact on movement of the apparatus over such carpeted surface. There is a moving and positioning means engageable with a predetermined portion of such flexible member for enabling moving and positioning the apparatus as required for an intended use. At least a portion of the moving and positioning means is attached to the predetermined portion of such flexible member.

### OBJECTS OF THE INVENTION

It is, therefore, one of the primary objects of the present invention to provide a combination indoor and outdoor slide usable on both hard surfaces and carpeted surfaces which requires a minimum number of component parts and is relatively inexpensive to manufacture.

Another object of the present invention is to provide a combination indoor and outdoor slide usable on both hard surfaces and carpeted surfaces which is easy to use.

Still another object of the present invention is to provide a combination indoor and outdoor slide usable on both hard surfaces and carpeted surfaces which is light weight.

Yet another object of the present invention is to provide a combination indoor and outdoor slide usable on both hard surfaces and carpeted surfaces which requires a minimum of maintenance.

A further object of the present invention is to provide a combination indoor and outdoor slide usable on both hard surfaces and carpeted surfaces which can be manufactured in a variety of sizes and shapes.

An additional object of the present invention is to provide a combination indoor and outdoor slide usable on both hard surfaces and carpeted surfaces which can be used on gravel and/or stone driveways or walkways.

It is another object of the present invention to provide a combination indoor and outdoor slide usable on both hard surfaces and carpeted surfaces which will exhibit a relatively long life.

Still yet another object of the present invention is to provide a combination indoor and outdoor slide usable on both hard surfaces and carpeted surfaces which does not require any moving parts.

A still further object of the present invention is to provide a combination indoor and outdoor slide usable on both hard surfaces and carpeted surfaces which can include a relatively soft cover to enable the slide to be used indoors on uncarpeted floors without marring the floor surface.

Another object of the present invention is to provide a combination indoor and outdoor slide usable on both hard surfaces and carpeted surfaces which can be equipped to receive a new sliding surface periodically as necessary.

Still another object of the present invention is to provide a combination indoor and outdoor slide usable on both hard surfaces and carpeted surfaces which does not require any assembly by the consumer.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing Figures and with the appended claims.

### BRIEF DESCRIPTION OF THE DRAWINGS

FIG. 1 is a partial perspective view of the apparatus according to an embodiment of the invention.

FIG. 2 is a side view of the apparatus shown in FIG. 1.

FIG. 3 is a cross sectional view of the apparatus shown in FIGS. 1 and 2 taken across the lines of III-III.

FIG. 4 is a partial perspective view of the apparatus according to other embodiments of the invention.

FIG. 5 is a side view of the apparatus shown in FIG. 4.

FIG. 6 is a partial perspective view of the apparatus according to another embodiment of the invention.

FIG. 7 is a side view of the apparatus shown in FIG. 6.

FIG. 8 is a partial perspective view of the apparatus according to still another embodiment of the invention.

FIG. 9 is a side view of the apparatus shown in FIG. 8.

FIG. 10 is a partial perspective view of the apparatus according to yet another embodiment of the invention.

FIG. 11 is a partial perspective view of the apparatus according to yet another embodiment of the invention.

FIG. 12 is a cross sectional view of the apparatus shown in FIG. 11 taken across the lines of XII-XII.

FIG. 13 is a side view of the apparatus shown in FIG. 11.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that identical components having identical functions have been designated with identical reference numerals throughout the several views illustrated in the drawings for the sake of clarity.

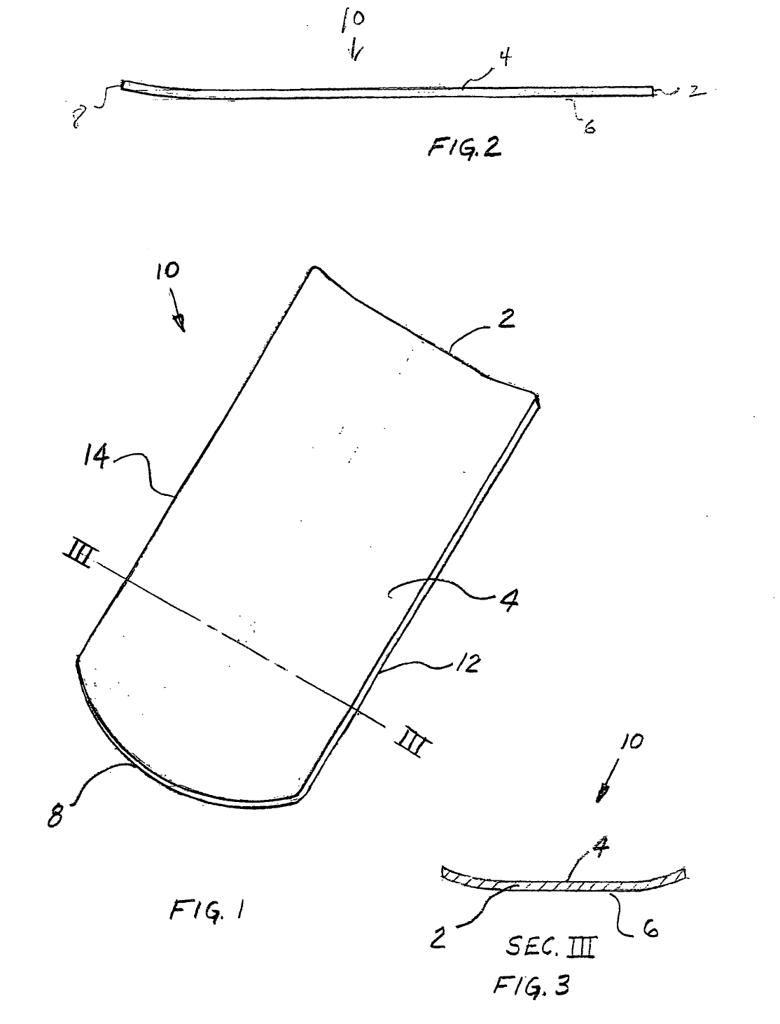

Now refer, more particularly, to the drawing Figures. FIGS. 1, 2 and 3 show an embodiment of the invention. Illustrated therein is a combination indoor and outdoor slide apparatus, generally designated 10, which is usable at least on each of a hard surface and a carpeted surface. The combination indoor and outdoor slide apparatus 10 comprises at least one (first) flexible member 2 having each of an upper surface 4 and a radially opposed bottom surface 6 engageable with either a hard surface or a carpeted surface (not shown). The apparatus 10 has a first predetermined thickness and a first predetermined coefficient of friction at least extending up from the bottom surface 6 for a predetermined depth which is at least sufficiently low to permit movement of the apparatus 10 over the predetermined surface when a load of up to about 300 pounds is disposed thereon. The flexible member 2 is formed into a first predetermined shape. The predetermined shape is substantially rectangular; however, a first end 8 of such flexible member 2 has an arcuate shape in a horizontal direction. Further, the first predetermined shape includes having the first end 8 also being arcuate in a vertical direction so as to permit easy sliding over any type of floor. It is also a preferred embodiment of the invention that a portion of the parallel sides 12 and 14 closely adjacent to the first end 8 also have an arcuate shape in a vertical direction so as to permit easy sliding in either direction. The first predetermined shape is at least devoid of any sharp edges which could be caught on such carpeted surface and which would have an adverse impact on movement of said apparatus over such carpeted surface.

Such apparatus 10 further includes a moving and positioning means, generally designated 20, that is engageable with a predetermined portion of such flexible member 2 for enabling moving and positioning the apparatus 10 as required for an intended use. At least a portion of the moving and positioning means 20 is attached to the predetermined portion of the flexible member 2.

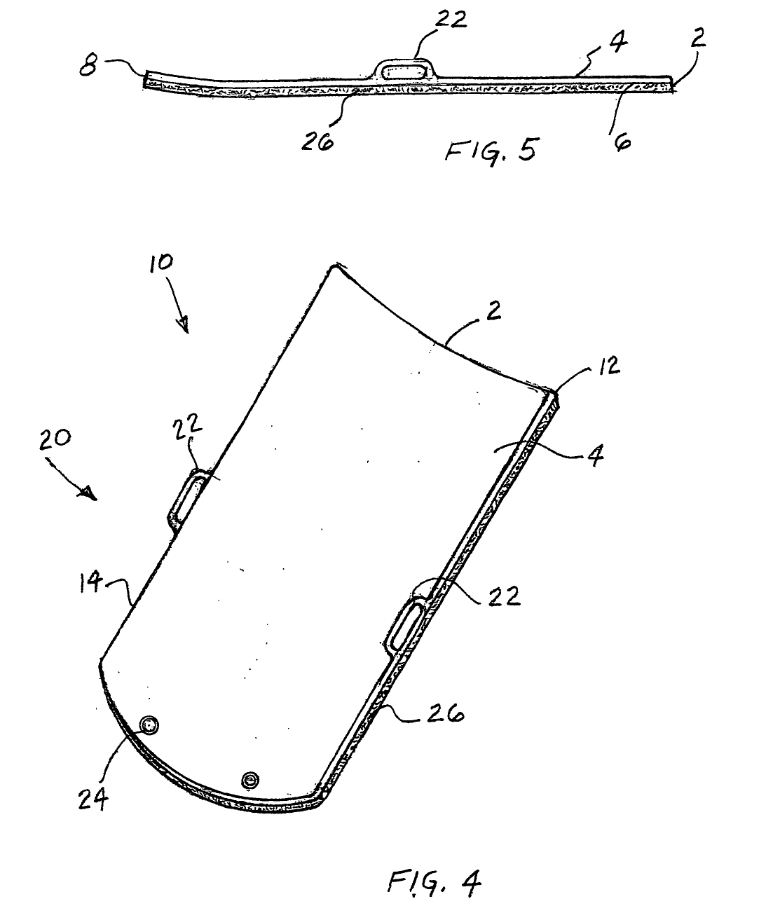

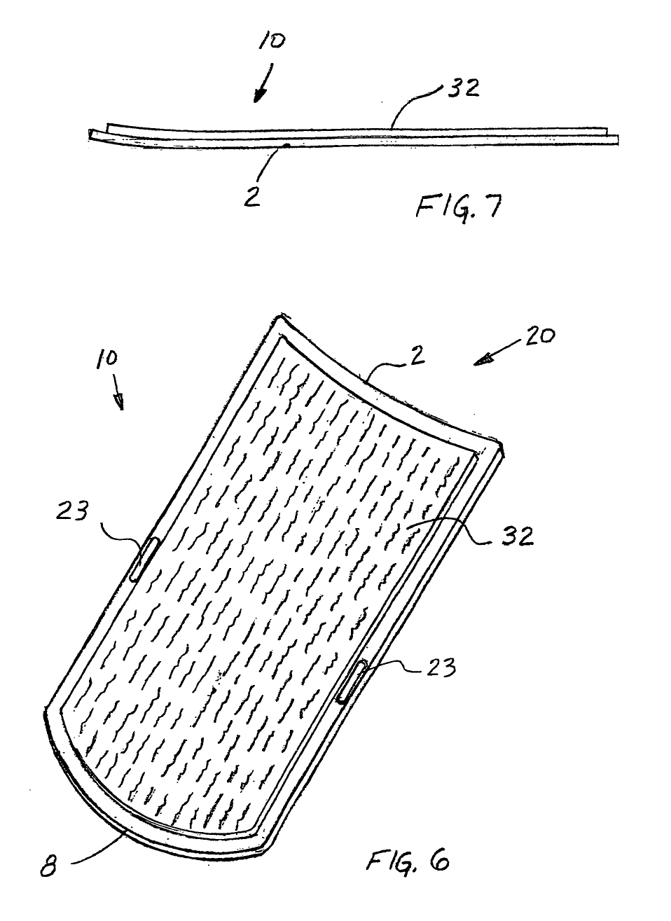

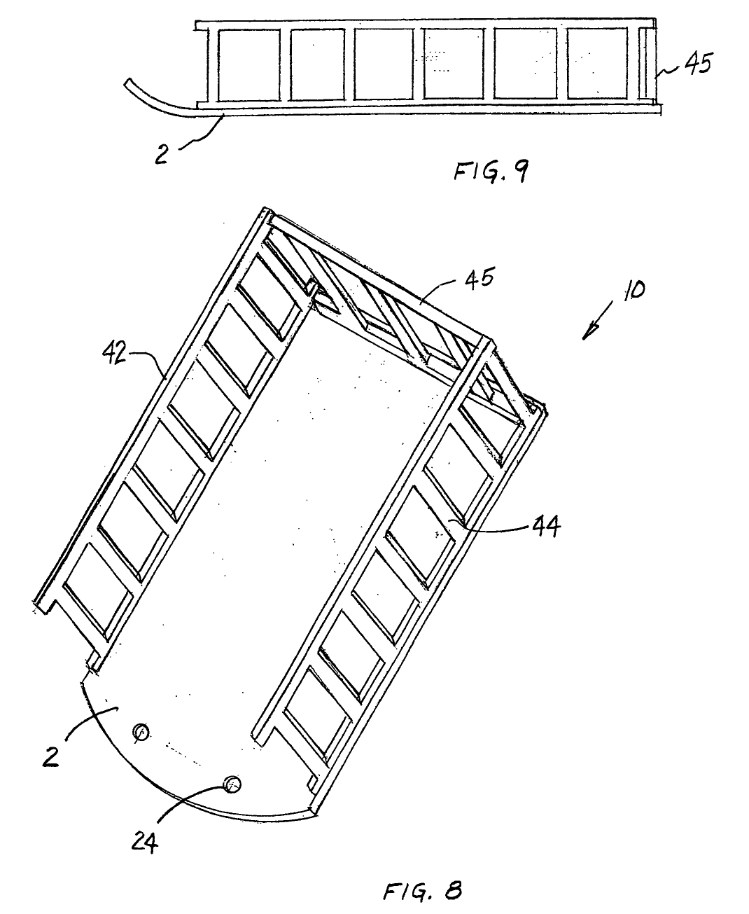

Illustrated in FIG. 4 are several of the possible moving and positioning means 20. One such method is the use of handles 22 that are attached to the flexible member 2 on the substantially parallel sides 12 and 14. In another embodiment the handles 23 are formed as an aperture through the flexible member 2 closely adjacent an edge thereof. One other such means 20 is the use of at least one opening with a grommet attached therein 24. It is presently preferred that when such means 20 uses such opening with grommet 24 that there be two openings with two grommets 24 used. A rope other such similar material may be used to attach to the flexible member 2 at the grommeted openings 24.

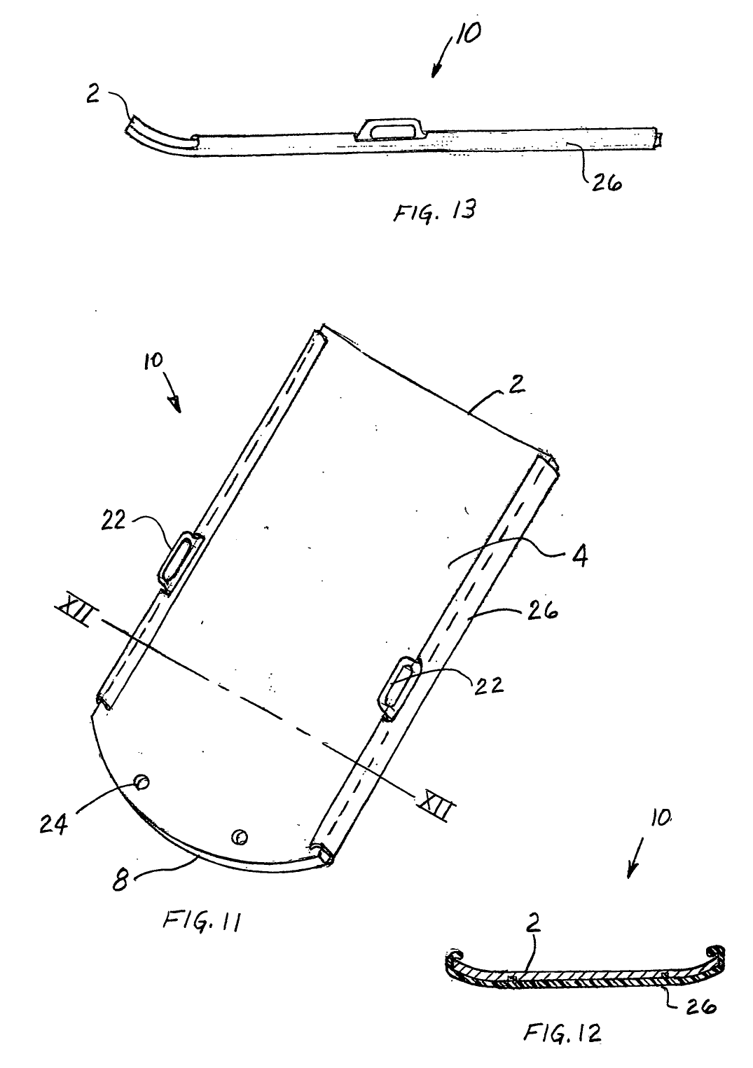

FIGS. 4,5,11,12 and 13 also show other embodiments of the invention in which the first flexible member 2 includes a second flexible member 26 which is attached to the bottom surface 6 of such flexible member 2. The use of a second flexible member 26 permits the use of different materials for such first flexible member 2 and such second flexible member 26. Such second flexible member 26 would be the sliding member and if it got damaged or marred in any way such second flexible member 26 could be replaced and the apparatus 10 would still be usable. This also would permit the use of a less costly material as the first flexible member 2. Such second flexible member 26 is attachable to said first flexible member 2 by means of a snap fit or friction fit (shown in FIGS. 11-13). It is within the scope of the invention that such second flexible member 26 could be made of felt (As seen in FIGS. 4 and 5) for specific use on hard and relatively smooth floors such as tile or wood floors.

FIG. 6 also shows a different moving and positioning means 20. In this embodiment the means 20 includes the use of a gripping material 32 that is adhered to a portion of the upper surface 4 of such first flexible member 2. Such gripping material 32, which is similar to material used for shelf liners such as that sold by Duck Products, permits the user to lie on the apparatus 10 and control movement of the apparatus substantially with the users shoulders wherein the gripping material 32 is such that the apparatus 10 will substantially stick to the back of the user and move as the user moves.

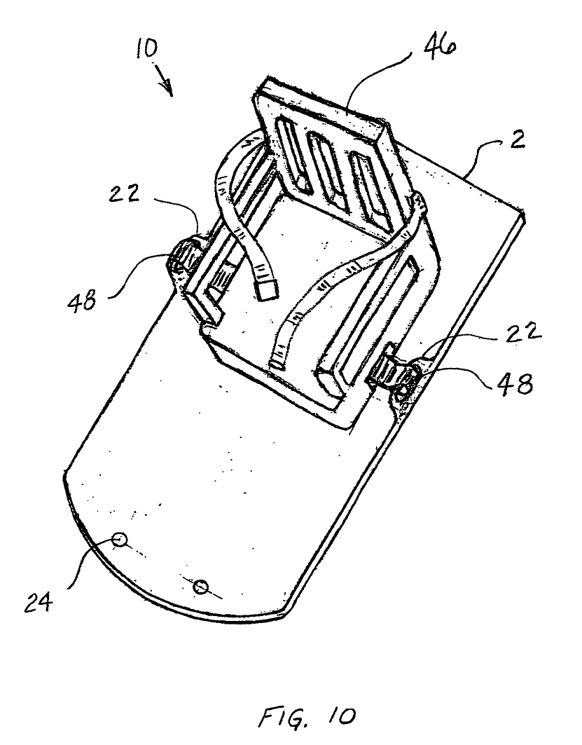

FIGS. 8-10 illustrate still other embodiments of the invention. Shown in FIGS. 8 and 9 are sidewalls 42, 44 and end wall 45 that are attached to the first flexible member 2 wherein such apparatus 10 is used to move preselected objects from one place to another. In one case such apparatus 10 could be used to carry groceries into the house or from one room to another or it can be used outdoors as a wagon or a wheel barrel. One means of attaching the sidewall(s) 42,44 and endwall 45 are with posts at the bottom of the sidewall and endwall which are inserted into apertures in the flexible member 2.

Illustrated in FIG. 10 is an infant car seat 46 that is attached to the flexible member 2. Such infant car seat 46 is attached to flexible member 2 by straps 48 that are engageable with the handles 22 so as to insure that the seat 46 is secured firmly to the flexible member 2. Such attachment could also be made to handles 23 which are formed as an aperture in flexible member 2 shown in another drawing Figure.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. A combination indoor and outdoor slide apparatus usable at least on each of a hard surface and a carpeted surface, said combination indoor and outdoor slide apparatus comprising:
(a) at least one flexible member having each of an upper surface and a radially opposed bottom surface engageable with one of a hard surface and a carpeted surface, a first predetermined thickness, a first predetermined coefficient of friction at least extending up from said bottom surface for a predetermined depth and which is at least sufficiently low to permit movement of said apparatus over a predetermined surface when a load of up to about 300 pounds is disposed thereon, said at least one flexible member being formed into a first predetermined shape, said first predetermined shape at least being devoid of any sharp edges which could be caught at least one of in and on such carpeted surface and which would have an adverse impact on movement of said apparatus over such carpeted surface; and
(b) a moving and positioning means engageable with a predetermined portion of said at least one flexible member for enabling moving and positioning said apparatus as required for an intended use, at least a portion of said moving and positioning means is attached to said predetermined portion of said at least one flexible member.

2. A combination indoor and outdoor slide apparatus, according to claim 1, wherein said apparatus further includes at least one resilient member having a second predetermined thickness, an upper surface, a bottom surface, a second predetermined coefficient of friction and a second predetermined shape, said bottom surface of said at least one resilient member disposed on and adhered to at least a portion of said upper surface of said at least one flexible member.

3. A combination indoor and outdoor slide apparatus, according to claim 2, wherein said second predetermined thickness is greater than said first predetermined thickness.

4. A combination indoor and outdoor slide apparatus, according to claim 2, wherein said second predetermined coefficient of friction is at least sufficiently high enough for at least a predetermined depth from said upper surface of said at least one resilient member which will enable said apparatus to be moved over a supporting surface due to friction between a back of a person laying on said apparatus and said upper surface of said resilient material thereby serving as said moving and positioning means engageable with said predetermined portion of said at least one flexible member for enabling moving and positioning said apparatus as required for an intended use.

5. A combination indoor and outdoor slide apparatus, according to claim 2, wherein said second predetermined shape is generally rectangular and includes an arcuate portion disposed at least at a front edge thereof.

6. A combination indoor and outdoor slide apparatus, according to claim 1, wherein said predetermined shape of said at least one flexible member is generally rectangular and includes an arcuate portion disposed at least at a front edge thereof.

7. A combination indoor and outdoor slide apparatus, according to claim 6, wherein said at least one flexible member further includes at least one upturned edge portion disposed adjacent at least said front thereof.

8. A combination indoor and outdoor slide apparatus, according to claim 7, wherein said at least one flexible member further includes an upturned edge portion disposed adjacent at least two radially opposed sides thereof.

9. A combination indoor and outdoor slide apparatus, according to claim 1, wherein said moving and positioning means engageable with said predetermined portion of said at least one flexible member includes at least one aperture formed through said at least one flexible member, said at least one aperture having a grommet secured therein, said grommet being engageable with a means for pulling said apparatus.

10. A combination indoor and outdoor slide apparatus, according to claim 9, wherein said means for pulling said apparatus includes a rope.

11. A combination indoor and outdoor slide apparatus, according to claim 1, wherein said moving and positioning means engageable with a predetermined portion of said at least one flexible member includes at least one handle member one of secured to said upper surface of said at least one flexible member and formed as an aperture through said at least one flexible member closely adjacent an edge thereof.

12. A combination indoor and outdoor slide apparatus, according to claim 11, wherein said moving and positioning means engageable with said predetermined portion of said at least one flexible member includes a pair of handle members at least one of secured to said upper surface of said at least one flexible member and formed as an aperture through said at least one flexible member closely adjacent radially opposed edges thereof.

13. A combination indoor and outdoor slide apparatus, according to claim 1, wherein said apparatus will be used as a creeper and said apparatus further includes a head rest engageable with said upper surface of said at least one flexible member.

14. A combination indoor and outdoor slide apparatus, according to claim 1, wherein said apparatus further includes at least one side wall engageable with an edge of said at least one flexible member.

15. A combination indoor and outdoor slide apparatus, according to claim 14, wherein said apparatus further includes a pair of side walls engageable with radially opposed side edges of said at least one flexible member and at least one end wall engageable with an end edge of said at least one flexible member.

16. A combination indoor and outdoor slide apparatus, according to claim 15, wherein said pair of side walls and said at least one end wall are removable.

17. A combination indoor and outdoor slide apparatus, according to claim 16, wherein said pair of side walls and said at least one end wall are formed from a substantially rigid material.

18. A combination indoor and outdoor slide apparatus, according to claim 1, wherein said at least one flexible member is chemically resistant.

19. A combination indoor and outdoor slide apparatus, according to claim 1, wherein said at least one flexible member further includes a second flexible member disposed on said radially opposed bottom surface of said at least one flexible member, said second flexible member engageable with one of a hard surface and a carpeted surface, said second flexible member having a third predetermined coefficient of friction which is at least sufficiently low to permit movement of said apparatus over a predetermined surface when a load of up to about 300 pounds is disposed thereon.

20. A combination indoor and outdoor slide apparatus, according to claim 19, wherein said second flexible member is attached to said apparatus by one of a snap fit and a friction fit.

21. A combination indoor and outdoor slide apparatus, according to claim 19, wherein said apparatus further includes an infant car seat.
